(19) United States
(12) Patent Application Publication
(10) Pub. No.: US 2024/0256873 A1
(43) Pub. Date: Aug. 1, 2024

(54) TRAINING NEURAL NETWORKS BY RESETTING DORMANT NEURONS

(71) Applicant: Google LLC, Mountain View, CA (US)

(72) Inventors: Utku Evci, Montreal (CA); Pablo Samuel Castro Rivadeneira, Ottawa (CA); Ghada AbdElRahman Zaki Nabawy Sokar, Eindhoven (NL); Rishabh Agarwal, Montreal (CA)

(21) Appl. No.: 18/424,633

(22) Filed: Jan. 26, 2024

Related U.S. Application Data
(60) Provisional application No. 63/441,441, filed on Jan. 26, 2023.

(51) Int. Cl. G06N 3/082; G06N 3/092

(52) U.S. Cl. CPC G06N 3/082; G06N 3/092

(57) ABSTRACT

Methods, systems, and apparatus, including computer programs encoded on computer storage media, for training a neural network and, during the training, resetting neurons that have been classified as being dormant.

### CROSS-REFERENCE TO RELATED APPLICATIONS

This application claims the benefit of U.S. Patent Application Ser. No. 63/441,441, filed on Jan. 26, 2023. The disclosure of the prior application is considered part of (and is incorporated by reference in) the disclosure of this application.

### BACKGROUND

This specification relates to training neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that trains a neural network that processes network inputs to generate network outputs. In particular, during the training, the system periodically resets neurons of the neural network that the system has classified as dormant neurons.

Particular embodiments of the subject matter described in this specification can be implemented so as to realize one or more of the following advantages.

This specification generally describes a technique for improving the performance of the training of a neural network, e.g., the training of a neural network through reinforcement learning, by repeatedly checking for “dormant” neurons in the neural network and modifying the incoming and outgoing weights of those neurons to reset the neurons to an “active” state in which the output of those neurons contributes to the overall output of the neural network. A dormant neuron is one that has become at least close to inactive because activations generated by the neuron have zero or close-to-zero expected values. When a significant amount of dormant neurons are present in the neural network, the capacity of the neural network is reduced and the improvement of the neural network during training can stagnate. By “resetting” these dormant neurons, the described techniques maintain the capacity of the network throughout training, thereby avoiding network under-utilization during training without sacrificing previously learned knowledge. Thus, by making use of the described techniques, a smaller neural network can achieve the same performance as a larger neural network trained using conventional techniques while being more computationally efficient at inference time than the larger neural network, e.g., because the described techniques effectively mitigate the impact of dormant neurons during training. Additionally, by making use of the described techniques, a neural network can be trained to achieve a desired level of performance in fewer training iterations relative to training using conventional techniques, e.g., because the described techniques effectively mitigate the impact of dormant neurons during training and therefore cause training to converge faster. As another example, when training a neural network through reinforcement learning, the system can make use of a higher replay ratio, i.e., a higher ratio of training steps to data collection steps. While increasing the replay ratio can increase the data efficiency of the training process, using higher replay ratios when training with conventional reinforcement learning techniques can result in a higher fraction of neurons turning dormant, hurting training quality. By making use of the described techniques, however, the higher replay ratio can effectively be employed without hurting training quality and while maintaining the data efficiency benefits. Thus, the neural network can be effectively trained in a manner that requires less training data to be collected, limiting how much computationally expensive data gathering is required for training. Additionally, when data gathering requires causing a mechanical or other agent to interact with a real-world environment, limiting the amount of data gathering reduces wear and tear on the agent, the environment, or both, and limits the risk of damage to the agent, the environment, or both.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example training system.

FIG. 2 is a flow diagram of an example process for performing a training step during the training of the neural network.

FIG. 3 is a flow diagram of an example process for determining whether to classify neurons as dormant neurons.

FIG. 4 shows an example of the performance of the described techniques relative to a set of baseline techniques.

Like reference numbers and designations in the various drawings indicate like elements.

### DETAILED DESCRIPTION

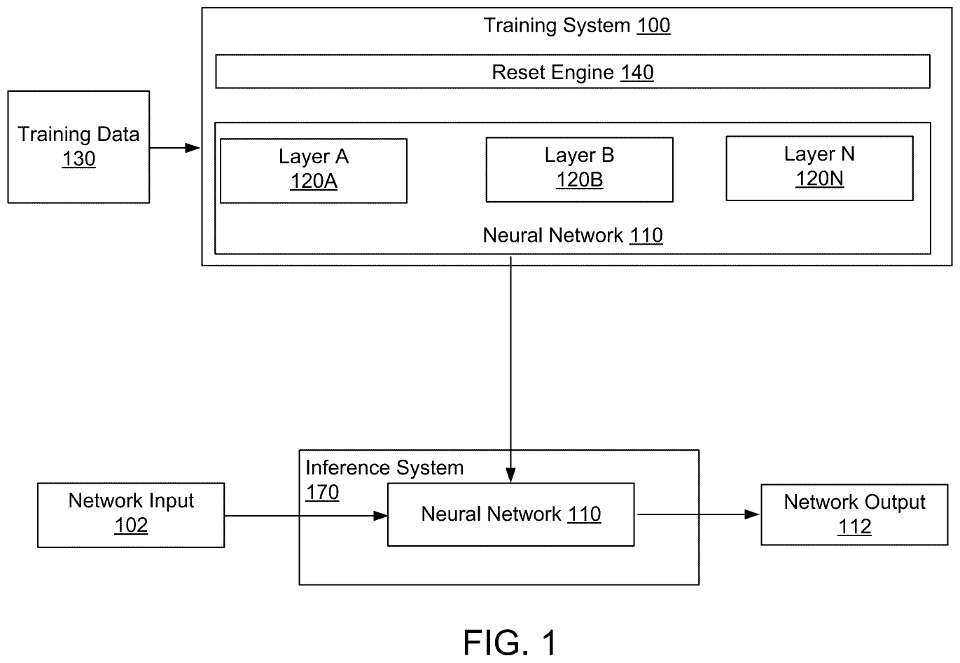

FIG. 1 shows an example training system 100. The training system 100 is an example of a system implemented as computer programs on one or more computers in one or more locations, in which the systems, components, and techniques described below can be implemented.

The system 100 trains a neural network 110 that is configured to perform a particular machine learning task on training data 130 to determine trained values of the parameters of the neural network. That is, the neural network 110 has parameters and is configured to process a network input 112 in accordance with the parameters to generate a network output 114 for the network input 112 for the particular machine learning task.

The neural network 110 can be trained to perform any kind of machine learning task, i.e., can be configured to receive any kind of digital data input and to generate any kind of score, classification, or regression output based on the input.

Generally, the system 100 can train a neural network 110 on any task where neural networks trained using conventional techniques suffer from an increasing number of inactive neurons as training progresses, thereby affecting the expressivity of the neural network and harming the effectiveness of the training process. In other words, when training using conventional techniques, the number of “dormant” neurons within the neural network increases as training progresses. A “dormant” neuron is a neuron that has become inactive or close to inactive due to activations generated by the neuron being zero or close to zero in expectation. That is, dormant neurons make little to no impact on the final predicted network output generated by the neural network because their activations (outputs) are frequently zero or close to zero. A training algorithm that exhibits this dormant neuron phenomenon is not using the neural network's capacity to its full potential, and this under-utilization only increases as training progresses.

This phenomenon can occur in many different tasks.

One example of such a task is a task where the target outputs that are computed by the training algorithm that is used to train the neural network are non-stationary, i.e., the targets change as training progresses. This target non-stationarity can cause the occurrence of the dormant neuron phenomenon.

More specifically, while the described techniques can generally be used to improve the training of any appropriate neural network 110 that is being trained using any appropriate training technique, in some implementations, the neural network 110 is a neural network that is being trained through reinforcement learning to be used for controlling an agent interacting with an environment to perform a task in the environment. That is, the network input 102 includes an observation characterizing the current state of the environment and the network output 112 defines an action to be performed by the agent when the environment is in the current state.

The use of reinforcement learning, rather than supervised learning, for this training causes the targets computed by the reinforcement learning technique to be non-stationary, e.g., because the targets are computed using the neural network that is being trained or another neural network that is being trained jointly with the neural network and the same network input can therefore have a different target network output as training progresses.

In these implementations, the system 100 trains the neural network 110 on trajectories sampled from a replay memory or other data structure that stores data characterizing interactions of the agent with the environment during the training.

For example, the neural network 110 can be the “policy neural network” described below.

As another example, the task can be a task that requires operating on time series data that is associated with non-stationary target outputs. For example, the task can be a time series prediction that has outputs that are influenced by external factors that are not reflected in the input features for the task, e.g., features of an external environment.

The neural network 110 can have any appropriate architecture that allows the neural network 110 to perform the particular machine learning task, i.e., to map network inputs of the type and dimensions required by the task to network outputs of the type and dimensions required by the task. That is, when the task is a classification task, the neural network 110 maps the input to the classification task to a set of scores, one for each possible class for the task. When the task is a regression task, the neural network 110 maps the input to the regression task to a set of regressed values, one for each value that needs to be generated in order to perform the regression task.

As one example, when the inputs are images, the neural network 110 can include a convolutional neural network, e.g., a neural network having a ResNet architecture, an Inception architecture, an EfficientNet architecture, and so on, or a Transformer neural network, e.g., a vision Transformer.

As another example, when the inputs include text, audio data or other sequential data, the neural network 110 can include a recurrent neural network, e.g., a long short-term memory (LSTM) or gated recurrent unit (GRU) based neural network, or a Transformer neural network.

As another example, the neural network can include a feed-forward neural network, e.g., an MLP, that includes multiple fully-connected layers.

Generally, the neural network 110 includes a plurality of neural network layers 120A-N, with any given one of the neural network layers 120A-N having a respective set of neurons.

Thus, the network parameters include, for each of these neurons, a respective set of incoming weights associated with the neuron and a respective set of outgoing weights associated with the neuron.

The “incoming weights” are the weights that are applied to inputs to the neuron and the “outgoing weights” are weights assigned to output of the neuron (also referred to as the “activation” of the neuron). For example, the outgoing weights of a given neuron in one layer can be the incoming weights assigned to the given neuron by the neurons in one or more other layers that are connected to the given neuron in the architecture of the neural network.

The system 100 performs the training across multiple training steps. At each of the training steps, the system obtains a set of training data for the training step from a larger set of training data 130 and trains the neural network 110 on the training data to update the network parameters.

To mitigate the impact of dormant neurons, at some or all of the training steps, a reset engine 140 within the system 100 can check whether the neural network 110 has neurons that have become dormant and, in response to determining that a given neuron has been classified as a dormant neuron, can “reset” the dormant neuron so that the previously dormant neuron is no longer dormant.

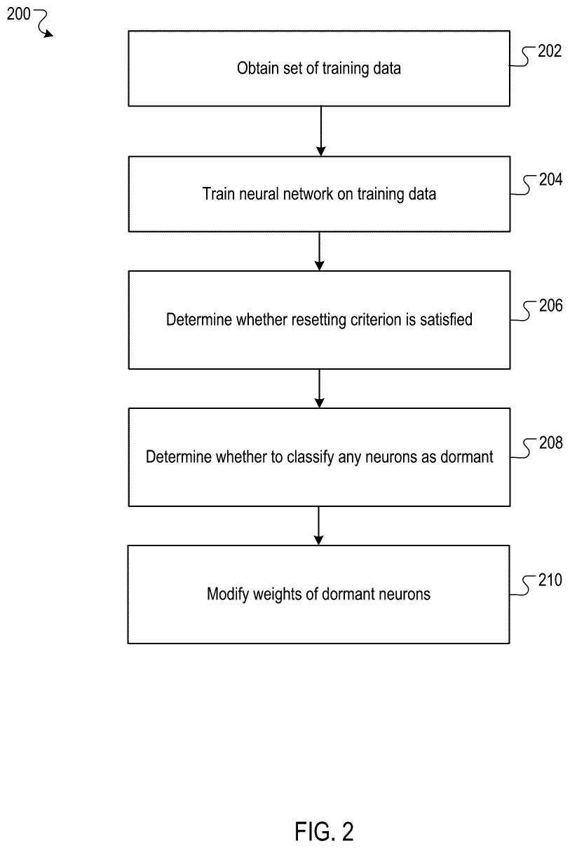

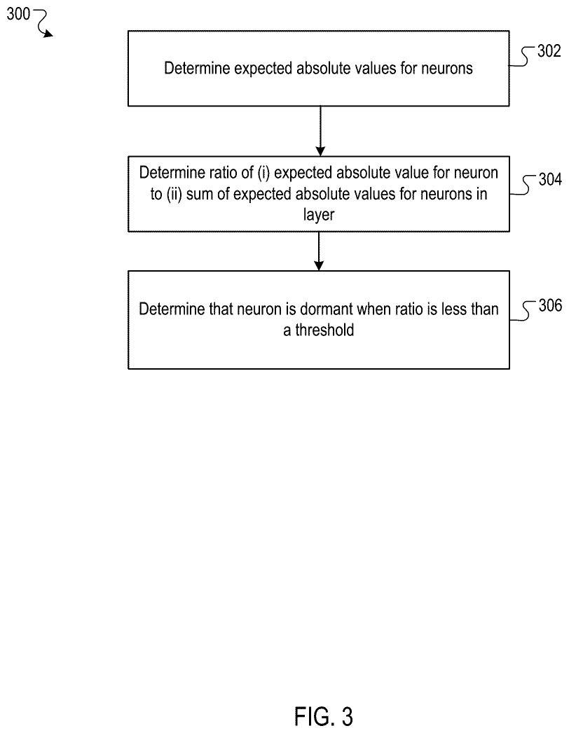

The operations performed by the reset engine 140 are described in more detail below with reference to FIGS. 2 and 3.

After training, the training system 100 or a different inference system 170 deploys the trained student neural network 110 on one or more computing devices to perform inference, i.e., to generate new network outputs 112 for the machine learning task for new network inputs 102.

FIG. 2 is a flow diagram of an example process 200 for performing a training step during the training of the neural network. For convenience, the process 200 will be described as being performed by a system of one or more computers located in one or more locations. For example, a training system, e.g., the training system 100 of FIG. 1, appropriately programmed, can perform the process 200.

The system can repeatedly perform iterations of the process 200 to repeatedly update the network parameters until a termination criterion has been satisfied, e.g., until a threshold number of iterations of the process 200 have been performed, until a threshold amount of wall clock time has elapsed, or until the values of the network parameters have converged. The system obtains a set of training data for the training step (step 202). For example, the system can sample a batch of training data from the replay memory or another data set that stores a larger amount of training data. The system will generally obtain different training inputs at different iterations, e.g., by sampling a fixed number of inputs from a larger set of training data at each iteration.

The system trains the neural network on the training data to update the network parameters (step 204). For example, the system can use the training data to determine gradients of a task objective function for the task with respect to the network parameters and then update the network parameters by applying an optimizer, e.g., the SGD optimizer, the Adam optimizer, the AdamW optimizer, the Adafactor optimizer, and so on, to the gradients.

The task objective function can be any appropriate differentiable objective function that is appropriate for the particular task, i.e., that measures the quality of an output generated by the neural network for a given input relative to a target output for the given input for the particular task. Examples of task objective functions include cross-entropy losses, squared error losses, negative log likelihood losses, and so on. In some cases, the task objective function may also include one or more additional terms, e.g., auxiliary loss terms, regularization terms, and so on, that do not depend on the label for the given input.

More specifically, when the neural network is being trained through reinforcement learning, the objective function can generally be any appropriate reinforcement learning objective, e.g., a Q-learning objective, an actor-critic objective, a policy gradient objective, a policy improvement objective, and so on.

The system determines whether a resetting criterion is satisfied at the training step (step 206). For example, the resetting criterion can be satisfied at every training step. As another example, the resetting criterion can be satisfied every F training steps, where F is a constant value that is greater than one.

In response to determining that the criterion is not satisfied, the system proceeds to the training step.

In response to determining that the criterion is satisfied, the system determines whether to classify any neurons within the neural network as being “dormant” (step 208). A “dormant” neuron is a neuron that has become inactive or close to inactive due to activations generated by the neuron being zero or close to zero in expectation. That is, dormant neurons make little to no impact on the final predicted network output generated by the neural network.

Classifying neurons as dormant will be described below with reference to FIG. 3.

In response to determining to classify a given neuron as a dormant neuron, the system modifies the incoming weights associated with the dormant neuron and the outgoing weights associated with the dormant neuron (step 210).

This serves to “reset” the dormant neuron so that the previously dormant neuron is no longer dormant, i.e., allows the subsequent training iterations to cause the dormant neurons to generate non-zero activations that will improve the quality of the outputs generated by the neural network.

As a particular example, to modify the incoming weights of a given neuron, the system can set the weights to values that have been initialized using a parameter initialization technique. As a particular example, at the beginning of training, the system can have initialized the weights of the neurons in each of the layers using a particular initialization technique and the system can use the same technique to set the new values for the weights of the given neuron. For example, the system can determine the new values by sampling values for the weights from a specified initialization distribution, e.g., using Glorot initialization or another similar initialization scheme. Thus, the system sets the incoming weights to values that can then be modified by the training algorithm to allow the neuron to generate outputs that contribute to the final network output.

As another particular example, to modify the incoming weights of a given neuron, the system can scale each incoming weight to the dormant neuron using a mean of incoming weights for neurons within the given layer that have not been classified as dormant neurons.

As a particular example, to modify the outgoing weights of a given neuron, the system can set the outgoing weights to zero. This ensures that the newly reset neuron will not negatively impact the performance of other neurons in other layers that receive the outputs of the neuron.

FIG. 3 is a flow diagram of an example process 300 for determining whether to classify any neurons in a given neural network layer as dormant neurons. For convenience, the process 300 will be described as being performed by a system of one or more computers located in one or more locations. For example, a training system, e.g., the training system 100 of FIG. 1, appropriately programmed, can perform the process 300.

As described above, the given neural network layers generally has multiple neurons, with each having a respective set of incoming and outgoing weights.

In some implementations, whenever the resetting criterion is satisfied, the system performs the process 300 for all of the layers of the neural network.

In some other implementations, whenever the resetting criterion is satisfied, the system performs the process 300 for only a proper subset of the layers of the neural network, with the proper subset having been identified by an input to the neural network before training begins or with the respective proper subset for the current training step being identified by an input to the system before the training step begins.

The system determines, for each of the neurons, an expected absolute value of an activation generated by the neuron during processing of a given network input (step 302).

In particular, the system can determine the expected absolute value for a given neuron as an average of absolute values of activations generated by the neuron during processing of each network input in a batch of network inputs.

For example, the batch of network inputs can be the network inputs in the set of training data for the current training step. As another example, the batch of network inputs can be an independently sampled batch (relative to the training data for the current training step), e.g., generated by sampling the batch from the replay memory or other larger set of training data. As yet another example, the batch can include some of the network inputs from the training data for the current training step and some network inputs that have been independently sampled.

The system then determines whether to classify each neuron as a dormant neuron based on the expected absolute value for the neuron.

As a particular example, the system can determine a ratio of (i) the expected absolute value for the neuron to (ii) a sum of the expected absolute values for the plurality of neurons in the given layer (step 304). The system can use the ratio instead of directly using the expected absolute value in order to normalize the ratios so that the ratios sum to 1 within a layer, thereby making the comparison of neurons in different layers possible.

The system then determines that the neuron is a dormant neuron when the ratio is less than a threshold value (step 306).

In some cases, the threshold value is equal to zero, so that the system only classifies neurons as dormant when resetting the neuron would leave the expected network output generated by the neural network unchanged, i.e., because the expected absolute value for the neuron is already zero.

In these cases, rather than compute the sum of the expected absolute values for the plurality of neurons, the system can determine that the neuron is a dormant neuron when the expected absolute value is equal to zero, i.e., because the ratio will only be equal to zero for a given neuron if the expected absolute value for the given neuron is equal to zero.

In some other cases, the threshold value is a small positive constant that is greater than zero. For example, the threshold value can be less than or equal to 0.1 (but greater than zero). In these cases, resetting a dormant neuron results in only a small expected change in the expected network outputs generated by the neural network. Thus, in either case, resetting dormant neurons does not negatively impact training quality. That is, because the expected output is (at worst) slightly changed, the knowledge already learned by the neural network during the training is retained even if dormant neurons are reset.

An example technique for training a neural network through reinforcement learning (RL) using the described techniques is represented as pseudo-code below in Table 1.

Algorithm 1 ReDo

```
Input: Network parameters θ, threshold τ₊ training steps
T, frequency F
for [symbol]  = [symbol] [symbol]   o to T do
  Update θ with regular RL loss
  If [symbol]  mod F == 0 then
    for each neuron i do
      If s [symbol]  ≤ τ then
        Reinitialize input weights of neuron i
        Set outgoing weights of neuron i to 0
      end If
    end for
  end If
end for [symbol]
indicates data missing or illegible when filed
```

In this example, sₗⁱ is the ratio computed for the i-th neuron for layer l of the neural network, and the network parameters θ include the incoming and outgoing weights of the neurons and optionally and for at least some of the neurons, bias values.

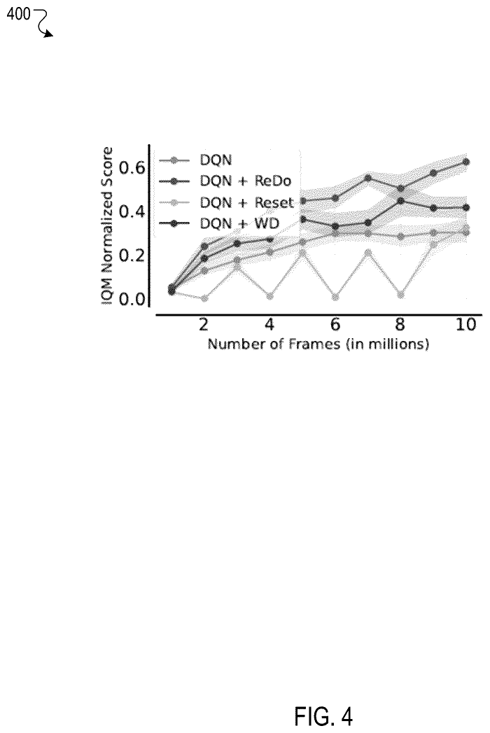

FIG. 4 is an example 400 of the performance of the described techniques (referred to as ReDo) relative to a set of baseline techniques.

In particular, each technique trains the same neural network using a Deep Q Network (DQN) reinforcement learning objective. One baseline technique (“DQN”) uses only DQN. Another baseline technique (“DQN+Reset”) also resets neurons during training but selects the neurons to be reset at random rather than based on whether the neuron has become dormant. Another baseline technique (“DQN+WD”) modifies the DQN technique by using weight decay in an attempt to avoid dormant neurons.

As can be seen from the example 400, the described techniques (“DQN+ReDo”), significantly outperform the baseline techniques (in terms of task performance, measured through an IQM normalized score, i.e., a score that measures performance of the agent on the task) throughout training (in terms number of image frames collected during training) as a result of being more effective in mitigating the impact of dormant neurons on training quality. As a result of this, the system can control the agent more effectively after training.

A description of controlling an agent using a policy neural network (which can be the neural network 110 that is trained through reinforcement learning by the system 100) now follows.

When controlling the agent, the system controls the agent to accomplish a task by selecting actions to be performed by the agent at each of multiple time steps during the performance of an episode of the task.

An “episode” of a task is a sequence of interactions during which the agent attempts to perform an instance of the task starting from some starting state of the environment. In other words, each task episode begins with the environment being in an initial state, e.g., a fixed initial state or a randomly selected initial state, and ends when the agent has successfully completed the task or when some termination criterion is satisfied, e.g., the environment enters a state that has been designated as a terminal state or the agent performs a threshold number of actions without successfully completing the task.

At each time step during any given task episode, the system receives an observation characterizing the current state of the environment at the time step and, in response, selects an action to be performed by the agent at the time step. After the agent performs the action, the environment transitions into a new state.

In some cases, the system also receives an extrinsic reward for the task (“task reward”) from the environment.

Generally, the extrinsic reward is a scalar numerical value and characterizes a progress of the agent towards completing the task.

As a particular example, the extrinsic reward can be a sparse binary reward that is zero unless the task is successfully completed and one if the task is successfully completed as a result of the action performed.

As another particular example, the extrinsic reward can be a dense reward that measures a progress of the agent towards completing the task as of individual observations received during the episode of attempting to perform the task, i.e., so that non-zero rewards can be and frequently are received before the task is successfully completed.

More specifically, to control the agent at a given time step, the system uses a policy neural network.

In one example, the policy output may include a respective numerical probability value for each action in a fixed set. The system can select the action, e.g., by sampling an action in accordance with the probability values for the action indices, or by selecting the action with the highest probability value.

In another example, the policy output may include a respective Q-value for each action in the fixed set. The system can process the Q-values (e.g., using a soft-max function) to generate a respective probability value for each action, which can be used to select the action (as described earlier), or can select the action with the highest Q-value.

The Q-value for an action is an estimate of a return that would result from the agent performing the action in response to the current observation and thereafter selecting future actions performed by the agent in accordance with current values of the parameters of the policy neural network and conditioned on the current goal.

As another example, when the action space is continuous, the policy output can include parameters of a probability distribution over the continuous action space and the system can select the action by sampling from the probability distribution or by selecting the mean action. A continuous action space is one that contains an uncountable number of actions, i.e., where each action is represented as a vector having one or more dimensions and, for each dimension, the action vector can take any value that is within the range for the dimension and the only constraint is the precision of the numerical format used by the system.

As yet another example, when the action space is continuous the policy output can include a regressed action, i.e., a regressed vector representing an action from the continuous space, and the system can select the regressed action as the action to be performed by the agent.

Some examples of the types of agents the system can control using the policy neural network now follow.

In some implementations, the environment is a real-world environment, the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements e.g. steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation e.g. steering, and movement e.g., braking and/or acceleration of the vehicle.

In some implementations the environment is a simulation of the above-described real-world environment, and the agent is implemented as one or more computers interacting with the simulated environment. For example the simulated environment may be a simulation of a robot or vehicle and the reinforcement learning system may be trained on the simulation and then, once trained, used in the real-world.

In some implementations the environment is a real-world manufacturing environment for manufacturing a product, such as a chemical, biological, or mechanical product, or a food product. As used herein a “manufacturing” a product also includes refining a starting material to create a product, or treating a starting material e.g. to remove pollutants, to generate a cleaned or recycled product. The manufacturing plant may comprise a plurality of manufacturing units such as vessels for chemical or biological substances, or machines, e.g. robots, for processing solid or other materials. The manufacturing units are configured such that an intermediate version or component of the product is moveable between the manufacturing units during manufacture of the product, e.g. via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g. minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment e.g. between the manufacturing units or machines. In general the actions may be any actions that have an effect on the observed state of the environment, e.g. actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

The rewards or return may relate to a metric of performance of the task. For example in the case of a task that is to manufacture a product the metric may comprise a metric of a quantity of the product that is manufactured, a quality of the product, a speed of production of the product, or to a physical cost of performing the manufacturing task, e.g. a metric of a quantity of energy, materials, or other resources, used to perform the task. In the case of a task that is to control use a resource the matric may comprise any metric of usage of the resource.

In general observations of a state of the environment may comprise any electronic signals representing the functioning of electronic and/or mechanical items of equipment. For example a representation of the state of the environment may be derived from observations made by sensors sensing a state of the manufacturing environment, e.g. sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions e.g. a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g. data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control e.g. cooling equipment, or air flow control or air conditioning equipment. The task may comprise a task to control, e.g. minimize, use of a resource, such as a task to control electrical power consumption, or water consumption. The agent may comprise an electronic agent configured to control operation of the items of equipment, or to control operation of the ancillary, e.g. environmental, control equipment.

In general the actions may be any actions that have an effect on the observed state of the environment, e.g. actions configured to adjust any of the sensed parameters described below. These may include actions to control, or to impose operating conditions on, the items of equipment or the ancillary control equipment, e.g. actions that result in changes to settings to adjust, control, or switch on or off the operation of an item of equipment or an item of ancillary control equipment.

In general observations of a state of the environment may comprise any electronic signals representing the functioning of the facility or of equipment in the facility. For example a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The rewards or return may relate to a metric of performance of the task. For example in the case of a task to control, e.g. minimize, use of a resource, such as a task to control use of electrical power or water, the metric may comprise any metric of use of the resource.

In some implementations the environment is the real-world environment of a power generation facility e.g. a renewable power generation facility such as a solar farm or wind farm. The task may comprise a control task to control power generated by the facility, e.g. to control the delivery of electrical power to a power distribution grid, e.g. to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements e.g. to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g. an efficiency of the conversion or a degree of coupling of the energy input to the electrical energy output. Electrical control actions may, for example, comprise actions that control one or more of a voltage, current, frequency or phase of electrical power generated.

The rewards or return may relate to a metric of performance of the task. For example in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general observations of a state of the environment may comprise any electronic signals representing the electrical or mechanical functioning of power generation equipment in the power generation facility. For example a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such sensors may include sensors configured to sense electrical conditions of the equipment such as current, voltage, power or energy; temperature or cooling of the physical environment; fluid flow; or a physical configuration of the equipment; and observations of an electrical condition of the grid e.g. from local or remote sensors. Observations of a state of the environment may also comprise one or more predictions regarding future conditions of operation of the power generation equipment such as predictions of future wind levels or solar irradiance or predictions of a future electrical condition of the grid.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions or chemical synthesis steps selected by the system automatically without human interaction. The observations may comprise direct or indirect observations of a state of the protein or chemical/intermediates/precursors and/or may be derived from simulation.

In a similar way the environment may be a drug design environment such that each state is a respective state of a potential pharmaceutically active compound and the agent is a computer system for determining elements of the pharmaceutically active compound and/or a synthetic pathway for the pharmaceutically active compound. The drug/synthesis may be designed based on a reward derived from a target for the drug, for example in simulation. As another example, the agent may be a mechanical agent that performs or controls synthesis of the drug.

In some further applications, the environment is a real-world environment and the agent manages distribution of tasks across computing resources e.g. on a mobile device and/or in a data center. In these implementations, the actions may include assigning tasks to particular computing resources.

As further example, the actions may include presenting advertisements, the observations may include advertisement impressions or a click-through count or rate, and the reward may characterize previous selections of items or content taken by one or more users.

In some cases, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

As another example the environment may be an electrical, mechanical or electro-mechanical design environment, e.g. an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e. observations of a mechanical shape or of an electrical, mechanical, or electro-mechanical configuration of the entity, or observations of parameters or properties of the entity. The actions may comprise actions that modify the entity e.g. that modify one or more of the observations. The rewards or return may comprise one or more metric of performance of the design of the entity. For example rewards or return may relate to one or more physical characteristics of the entity such as weight or strength or to one or more electrical characteristics of the entity such as a measure of efficiency at performing a particular function for which the entity is designed. The design process may include outputting the design for manufacture, e.g. in the form of computer executable instructions for manufacturing the entity. The process may include making the entity according to the design. Thus a design an entity may be optimized, e.g. by reinforcement learning, and then the optimized design output for manufacturing the entity, e.g. as computer executable instructions; an entity with the optimized design may then be manufactured.

As previously described the environment may be a simulated environment. Generally in the case of a simulated environment the observations may include simulated versions of one or more of the previously described observations or types of observations and the actions may include simulated versions of one or more of the previously described actions or types of actions. For example the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. Generally the agent may be implemented as one or more computers interacting with the simulated environment.

The simulated environment may be a simulation of a particular real-world environment and agent. For example, the system may be used to select actions in the simulated environment during training or evaluation of the system and, after training, or evaluation, or both, are complete, may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

As another example, in some implementations the agent comprises a digital assistant such as a smart speaker, smart display, or other device and the actions performed by the agent are outputs generated by the digital assistant in response to inputs from a human user that specify the task to be performed. The outputs may be provided using natural language, e.g. on a display and/or using a speech synthesis subsystem of the digital assistant. Visual, e.g. video, and/or audio observations of the user may be captured, e.g. using the digital assistant.

In some implementations, the agent is a chatbot or other software system that interacts with a user, where the observations are the context of the dialogue with the user (e.g., the current user input and optionally previous user inputs and corresponding outputs), and the actions are outputs generated by the chatbot and selected by the policy neural network, e.g., natural language text outputs, images, or videos. For example, user inputs may be natural language questions or other statements or may include data from other modalities, e.g., images, videos, or audio inputs. In some implementations, the chatbot can be implemented as a software system on the digital assistant described above.

Optionally, in any of the above implementations, the observation at any given time step may include data from a previous time step that may be beneficial in characterizing the environment, e.g., the action performed at the previous time step, the reward received at the previous time step, or both.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method of training a neural network having network parameters and configured to process a network input to generate a network output for the network input, the neural network comprising:
a plurality of neural network layers, the plurality of neural network layers comprising a first neural network layer having a plurality of neurons, and the network parameters comprising:
for each of the neurons, a respective set of incoming weights associated with the neuron and a respective set of outgoing weights associated with the neuron, the method comprising:
at each of a plurality of training steps:
obtaining a set of training data for the training step;
training the neural network on the training data to update the network parameters;
determining whether a resetting criterion is satisfied at the training step;
in response to determining that the criterion is satisfied:
determining, for each of the plurality of neurons, an expected absolute value of an activation generated by the neuron during processing of a given network input;
determining, for each neuron and based on the expected absolute value for the neuron, whether to classify the neuron as a dormant neuron; and
for any neuron that is classified as a dormant neuron, modifying the incoming weights associated with the dormant neuron and the outgoing weights associated with the dormant neuron.

2. The method of claim 1, wherein the neural network is used to control an agent interacting with an environment and wherein training the neural network comprises training the neural network through reinforcement learning on trajectories sampled from a replay memory.

3. The method of claim 1, wherein modifying the incoming weights comprises:
setting the weights to values that have been initialized using a parameter initialization technique.

4. The method of claim 3, wherein initializing the weights using the parameter initialization technique comprises sampling values for the weights from a specified initialization distribution.

5. The method of claim 1, wherein modifying the incoming weights comprises:
scaling each incoming weight to the dormant neuron using a mean of incoming weights for neurons that have not been classified as dormant neurons.

6. The method of claim 1, wherein modifying the outgoing weights comprises:
setting the outgoing weights to zero.

7. The method of claim 1, wherein determining whether to classify the neuron as a dormant neuron comprises:
for each neuron:
determining a ratio of (i) the expected absolute value for the neuron to (ii) a sum of the expected absolute values for the plurality of neurons; and
determining that the neuron is a dormant neuron when the ratio is less than a threshold value.

8. The method of claim 7, wherein the threshold value is less than or equal to 0.1.

9. The method of claim 1, wherein determining whether to classify the neuron as a dormant neuron comprises:
determining that the neuron is a dormant neuron when the expected absolute value is equal to zero.

10. The method of claim 1, wherein determining, for each of the plurality of neurons, an expected absolute value of an activation generated by the neuron during processing of a given network input comprises, for each neuron:
determining an average of absolute values of activations generated by the neuron during processing of each network input in a batch of network inputs.

11. The method claim 10, wherein the neural network is used to control an agent interacting with an environment and wherein training the neural network comprises training the neural network through reinforcement learning on trajectories sampled from a replay memory, the method further comprising:
sampling the batch from the replay memory.

12. The method of claim 10, wherein the batch of network inputs includes one more network inputs that are not in the set of training data for the training iteration.

13. The method of claim 10, wherein the batch of network inputs includes one more network inputs that are in the set of training data for the training iteration.

14. The method of claim 1, wherein determining whether a resetting criterion is satisfied at the training step comprises:
determining that the resetting criterion is satisfied when N training steps have elapsed after a preceding training step at which the resetting criterion was satisfied, wherein N is an integer greater than one.

15. A system comprising:
one or more computers; and
one or more storage devices communicatively coupled to the one or more computers, wherein the one or more storage devices store instructions that, when executed by the one or more computers, cause the one or more computers to perform operations for training a neural network having network parameters and configured to process a network input to generate a network output for the network input, the neural network comprising:
a plurality of neural network layers, the plurality of neural network layers comprising a first neural network layer having a plurality of neurons, and the network parameters comprising:
for each of the neurons, a respective set of incoming weights associated with the neuron and a respective set of outgoing weights associated with the neuron, the operations comprising:
at each of a plurality of training steps:
obtaining a set of training data for the training step;
training the neural network on the training data to update the network parameters;
determining whether a resetting criterion is satisfied at the training step;
in response to determining that the criterion is satisfied:
determining, for each of the plurality of neurons, an expected absolute value of an activation generated by the neuron during processing of a given network input;
determining, for each neuron and based on the expected absolute value for the neuron, whether to classify the neuron as a dormant neuron; and
for any neuron that is classified as a dormant neuron, modifying the incoming weights associated with the dormant neuron and the outgoing weights associated with the dormant neuron.

16. The system of claim 15, wherein the neural network is used to control an agent interacting with an environment and wherein training the neural network comprises training the neural network through reinforcement learning on trajectories sampled from a replay memory.

17. The system of claim 15, wherein modifying the incoming weights comprises:
setting the weights to values that have been initialized using a parameter initialization technique.

18. The system of claim 17, wherein initializing the weights using the parameter initialization technique comprises sampling values for the weights from a specified initialization distribution.

19. The system of claim 15, wherein modifying the outgoing weights comprises:
setting the outgoing weights to zero.

20. One or more non-transitory computer storage media storing instructions that when executed by one or more computers cause the one or more computers to perform operations for training a neural network having network parameters and configured to process a network input to generate a network output for the network input, the neural network comprising:
a plurality of neural network layers, the plurality of neural network layers comprising a first neural network layer having a plurality of neurons, and the network parameters comprising:
for each of the neurons, a respective set of incoming weights associated with the neuron and a respective set of outgoing weights associated with the neuron, the operations comprising:
at each of a plurality of training steps:
obtaining a set of training data for the training step;
training the neural network on the training data to update the network parameters;
determining whether a resetting criterion is satisfied at the training step;
in response to determining that the criterion is satisfied:
determining, for each of the plurality of neurons, an expected absolute value of an activation generated by the neuron during processing of a given network input;
determining, for each neuron and based on the expected absolute value for the neuron, whether to classify the neuron as a dormant neuron; and
for any neuron that is classified as a dormant neuron, modifying the incoming weights associated with the dormant neuron and the outgoing weights associated with the dormant neuron.
